(19) United States
(12) Patent Application Publication
(10) Pub. No.: US 2012/0096253 A1
(43) Pub. Date: Apr. 19, 2012

(54) METHOD FOR AUTOMATICALLY SETTING UP SYSTEM

(75) Inventors: Ying-Chih Lu, Taipei City (TW); Sheng-W Tseng, Taipei City (TW)

(73) Assignee: INVENTEC CORPORATION, Taipei City (TW)

(21) Appl. No.: 13/022,582

(22) Filed: Feb. 7, 2011

(30) Foreign Application Priority Data
Oct. 13, 2010 (TW) 99134927

(51) Int. Cl. G06F 9/24

(52) U.S. Cl. 713/2

(57) ABSTRACT

A method for automatically optimizing a configuration of a BIOS is suitable for configurating a computer system. During a BIOS power-on self test, a running operating system predetermined index is obtained from a memory. An optimal system setting parameter corresponding to the running operating system predetermined index is obtained. The computer system is automatically set up according to the optimal system setting parameter. A booting process is performed to start an operating system. An operating system index of the operating system is obtained. The operating system index is compared with the running operating system predetermined index. When the operating system index is not equal to the running operating system predetermined index, a system setting warning is issued. The running operating system predetermined index is updated by using the operating system index as the updated running operating system predetermined index in the memory.

### CROSS-REFERENCE TO RELATED APPLICATION

This application claims the priority benefit of Taiwan application serial no. 99134927, filed on Oct. 13, 2010. The entirety of the above-mentioned patent application is hereby incorporated by reference herein and made a part of this specification.

### BACKGROUND OF THE INVENTION

1. Field of the Invention

The invention relates to a method for automatically setting up a system, particularly to a method for automatically optimizing a configuration of a basic input/output system (BIOS) based on a type of a running operating system during BIOS power-on self test.

2. Description of Related Art

Operating system is a program managing resource of computer hardware and software, which is the core and foundation of a computer system. An operating system is in charge of managing and allocating networks and docket systems. An operation system also provides an interface to the users for interacting with the system.

From early text-based interfaces to existing graphical interfaces, the development of operating systems is tightly connected to hardware, and different operating systems are supported by different computer architectures. The modern desktop computers, for example, have various choices of operating systems. Each of the operating systems has specialized performance in its specific niche field of application. Thus, with the ever-growing capacity of storage devices, users install one or more operating systems in each computer host depending on their needs.

When multiple operating systems are installed in one computer system, a menu is provided to the users when the computer system is booted up. When the users select one of the operating systems, they have to manually set up the BIOS according to the operating system they select and simultaneously take the system settings provided by the computer system into account. However, when the system settings related to the operating system are not set appropriately, performance of the computer system is compromised. Besides, when an operating system starts up, the users have to select correct options of setting during a BIOS power-on self test, which is rather inconvenient to the users. Furthermore, if the users do not have sufficient knowledge of the operating system, they are not able to select correct system settings for the selected operating system, thus increasing possible human operation errors.

### SUMMARY OF THE INVENTION

The invention relates to a method for automatically optimizing a configuration of a basic input/output system (BIOS), which reduces operational complexity of a computer system, improves usability and reduces operational errors made by users.

The invention provides a method for automatically optimizing a configuration of a basic input/output system (BIOS), suitable for a computer system, and the method comprising: obtaining a running operating system predetermined index from a memory during a BIOS power-on self test; obtaining an optimal system setting parameter corresponding to the running operating system; automatically setting up the computer system according to the optimal system setting parameter; performing a booting process to start an operating system; obtaining an operating system index of the operating system; comparing the operating system index with the running operating system predetermined index, issuing a system setting warning when the operating system index is not equal to the running operating system predetermined index; updating the running operating system predetermined index by using the operating system index as the updated running operating system predetermined index in the memory.

According to an embodiment of the invention, in the method for automatically optimizing the configuration of the BIOS, the step of obtaining the operating system index of the operating system includes: obtaining an operating system string by querying an advanced configuration and power interface (ACPI) driver of the operating system; obtaining the operating system index of the operating system by referring to a look-up table according to the operating system string.

According to an embodiment of the invention, in the method for automatically optimizing the configuration of the BIOS, the step of comparing the operating system index with the running operating system predetermined index includes: sending the operating system index to a system management interrupt handler through an input/output data port to trigger a system management interruption and enter a system management mode. In the system management mode, the system management interrupt handler compares the operating system index with the running operating system predetermined index in the memory.

According to an embodiment of the invention, in the method for automatically optimizing the configuration of the BIOS, wherein the system management interrupt handler issues a system setting warning when the operating system index is not equal to the operating system predetermined index.

According to an embodiment of the invention, in the method for automatically optimizing the configuration of the BIOS, wherein the step of updating the operating system predetermined index of the running operating system is performed by the system management interrupt handler.

According to an embodiment of the invention, the method for automatically optimizing the configuration of the BIOS further comprises exiting the system management mode after updating the running operation system predetermined index.

According to an embodiment of the invention, in the method for automatically optimizing the configuration of the BIOS, wherein the step of exiting the system management mode comprises executing a Resume instruction.

According to an embodiment of the invention, the memory is a non-volatile random access memory.

According to an embodiment of the invention, the method for automatically optimizing the configuration of the BIOS further includes: re-executing the booting process after the running operating system predetermined index is updated and automatically setting up the computer system according to the updated running operating system predetermined index.

According to an embodiment of the invention, the operating system predetermined index is a previous running operating system index or a system-default operating system index.

Based on the above description, the last normally operated operating system is recorded and serves as the basis of starting the operating system during next system booting. During a BIOS power-on self test, an optimal system setting parameter of the corresponding BIOS is obtained according to the operating system predetermined index stored in the memory, and the computer system is automatically set up accordingly. Therefore, the system setting options related to types of operating systems can be deleted, simplifying operation of a computer system, improving usability and reducing operation errors made by the user.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart showing a method for automatically optimizing a configuration of a BIOS according to an embodiment of the invention.

FIG. 2 is a schematic view of a computer system using the method for automatically optimizing a configuration of a BIOS according to an embodiment of the invention.

FIG. 3 is a simplified flowchart showing a step of obtaining an operating system index of an operating system according to an embodiment of the invention.

FIG. 4 is a simplified flowchart showing a step of comparing the operating system index of an operating system with a running operating system predetermined index according to an embodiment of the invention.

### DESCRIPTION OF THE EMBODIMENTS

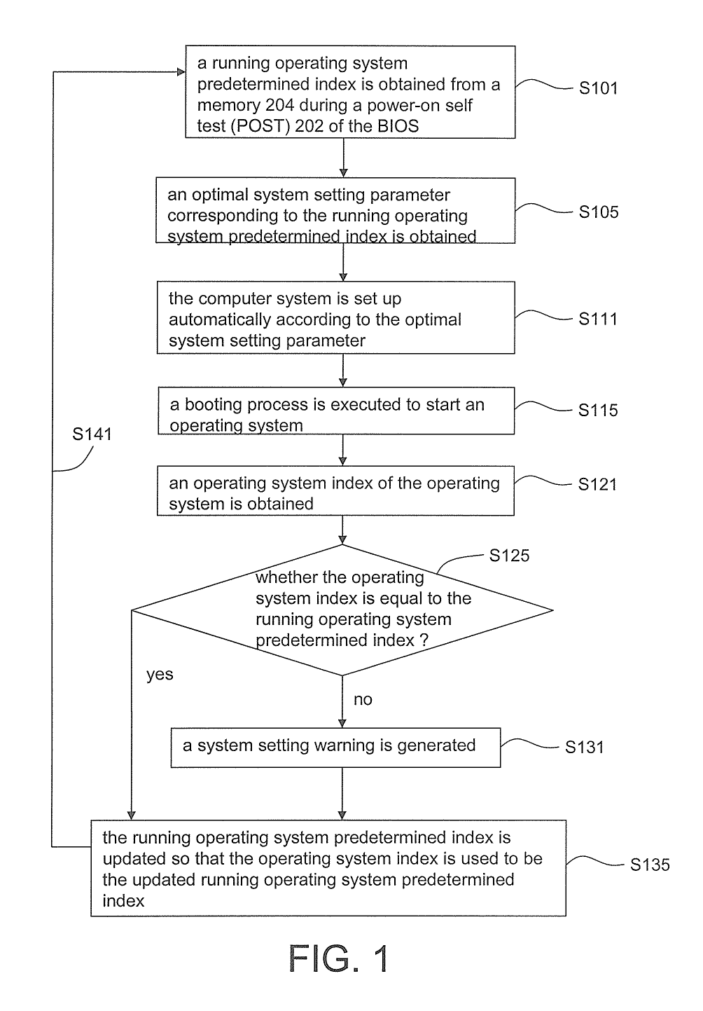

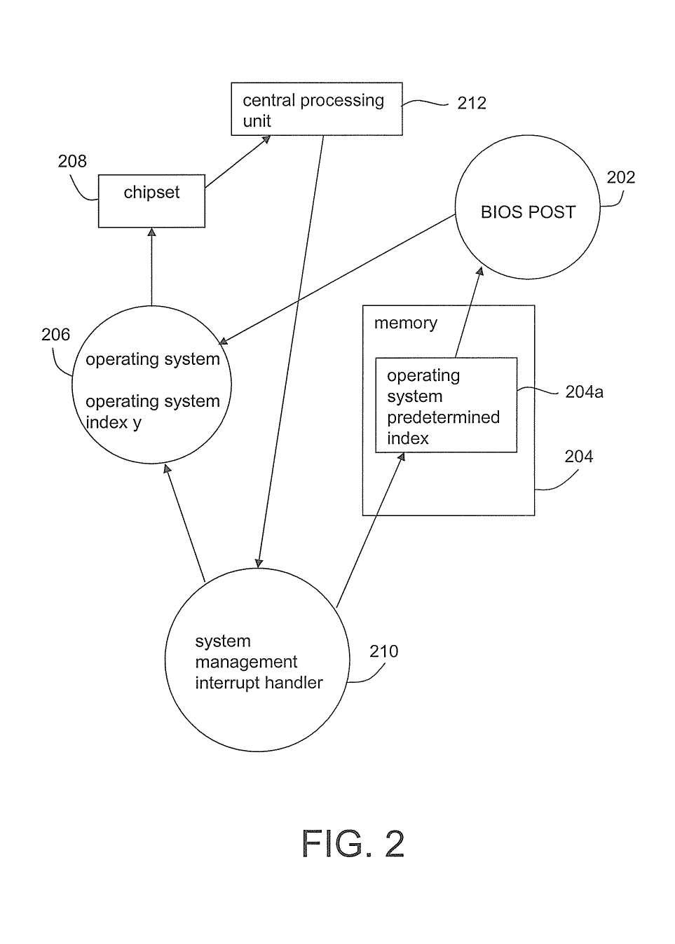

FIG. 1 is a flowchart showing a method for automatically optimizing a configuration of a BIOS according to an embodiment of the invention. FIG. 2 is a schematic view of a computer system using the method for automatically optimizing a configuration of a BIOS according to an embodiment of the invention. With reference to FIG. 1 and FIG. 2, a running operating system predetermined index is obtained from a memory 204 during a power-on self test (POST) 202 of the BIOS at step S101. The memory 204 is, for example, a non-volatile random access memory (NVRAM). The running operating system predetermined index is, for example, stored in an operating system predetermined column 204a of the memory 204. In the embodiment, the running operating system predetermined index is, for example, x.

In addition, in one embodiment, the running operating system predetermined index is the previous running operating system index. However, if the computer is booted up first time and there is no previous record of running the operating system, the running operating system predetermined index shown in the column 204a of the memory 204 is zero, and the operating system index of the default operating system is used as the running operating system predetermined index.

On the other hand, the operating system index reflects the corresponding types of operating systems by referring to a look-up table. For instance, the look-up table 1 shows several operating system indices and the corresponding types of operating systems.

Look-up table 1

| Operating system string | | |
|---|---|---|
| (which is received from ad- | | |
| vanced configuration and | Types of operating | Operating |
| power interface driver) | system | system index |
| Windows 2008 | Windows Longhorn | 12 |
| | server (Windows 2008) | |
| Windows 2007 | Windows Longhorn | 11 |
| | server (Windows 2007) | |
| Windows 2006.1 | Windows Longhorn | 10 |
| | server (Windows 2006.1) | |
| Windows 2006 | Windows Vista | 9 |
| Windows 2001.1 | Windows 2003 server | 5 |
| Windows 2001 | Windows XP OS | 4 |
| Windows 2000 | Windows 2000 server | 3 |
| FreeBSD | FreeBSD | 6 |
| HP-UX | HP-UX | 7 |
| OpenVMS | OpenVMS | 8 |
| Microsoft WindowsNT | Windows 98 & SE | 1 |
| Microsoft WindowsME: | Windows Me | 2 |
| Millennium Edition | | |

The operating systems and the types thereof listed in the look-up table 1 are only for convenience of description only and serve no restriction of the invention.

At step S105, an optimal system setting parameter corresponding to the running operating system predetermined index is obtained during a BIOS power-on self test. In one embodiment, the step of obtaining an optimal system setting parameter corresponding to the running operating system predetermined index can be performed by referring to a look-up table, wherein each running operating system predetermined index corresponds to one operating system type, and each operating system type corresponds to one optimal system setting parameter. An optimal system setting parameter corresponding to the running operating system predetermined index can be retrieved by referring to the look-up table (for instance, Windows 2008 Server is the NUMA-aware (Non-Uniform Memory Access-aware) operating system so that enablement of NUMA is the optimal setting parameters of the operating system).

In step S111, the computer system is set up automatically according to the optimal system setting parameter, for example, the hardware setting, during a power-on self test (POST) 202 of the BIOS (for instance, according to the parameters of the NUMA enablement, the chipset is set to that the system memory address space is non-uniform memory access distribution space).

In step 115, a booting process is executed to start an operating system 206. At a running state of the operating system 206, an operating system index of the operating system 206 is obtained. According to this embodiment, the operating system index is, for example, y (step S121).

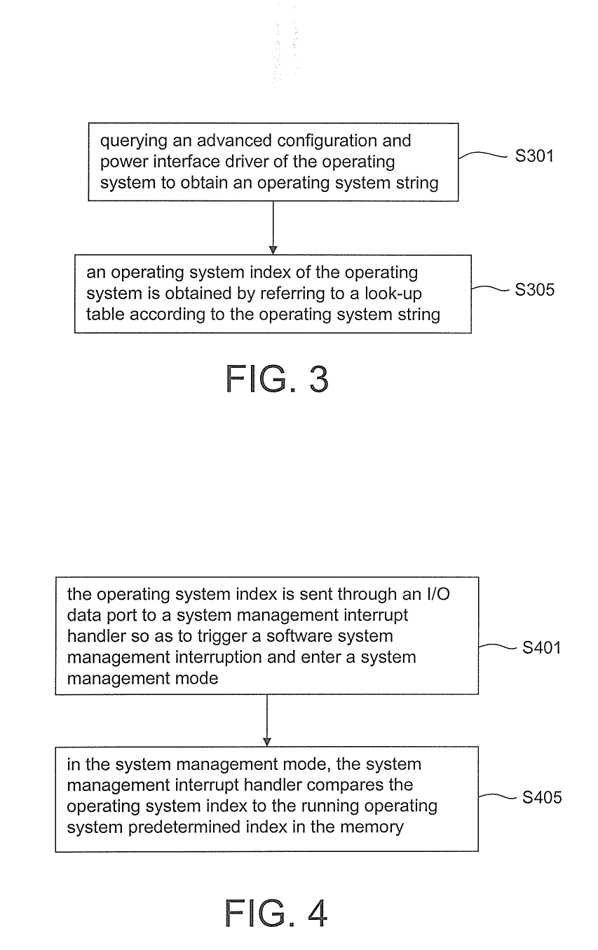

FIG. 3 is a flowchart showing the step of obtaining an operating system index according to an embodiment of the invention. As shown in FIG. 3, in one embodiment, the step of obtaining the operating system index y of the operating system 206 comprises querying an advanced configuration and power interface (ACPI) driver of the operating system 206 to obtain an operating system string when the operating system 206 is in the running state (step S301). More specifically, the APCI machine language (AML) program of the BIOS calls the particular program of the APCI driver (e.g. ACPI method_OS or OSI) to obtain a string response from the running operating system 206. The operating system string (or the string response) is, for example, a type of the operating system 206. After that, an operating system index of the operating system 206 is obtained by referring to a look-up table according to the operating system string (step S305). In the embodiment, the look-up table is, for example, the lookup table 1.

With reference to FIG. 1 and FIG. 2, whether the operating system index y is equal to the running operating system predetermined index x is determined in step S125. FIG. 4 is a flowchart showing a step of comparing the operating system index with a running operating system predetermined index according to an embodiment of the invention. As indicated in FIG. 4, in this embodiment, the step of determining whether the operating system index y is equal to the running operating system predetermined index x comprises sending the operating system index y through an I/O data port (e.g. I/O port B3h) in a chipset 208 to a system management interrupt handler (referred to as “SMI handler” hereafter) 210 so as to trigger a software system management interruption (Software SMI) and enter a system management mode (SMM) (step S401). In other words, a system management interruption is triggered to a central processing unit (CPU) 212, and the SMI handler 210 is executed by the CPU 212. The chipset 208 is, for example, a south bridge chipset. In the system management mode, the SMI handler 210 compares the operating system index y to the running operating system predetermined index x in the memory 204 (step S405).

With reference to FIG. 1 and FIG. 2, when the operating system index y is not equal to the running operating system predetermined index x, a system setting warning is generated by the SMI handler 210 (as shown in step S131, and, for instance, the power indicating light blinks in a specific way) to inform the user that the currently running operating system does not run in an optimized system setting environment. If the operating system index y is equal to the running operating system predetermined index x, then proceed with step S135. Likewise, if a system setting warning is generated in the step S131, then proceed with the step S135.

In step S135, the running operating system predetermined index is updated, and the running operating system predetermined index x in the memory 204 is replaced by the currently running operating system index y, i.e. the updated running operating system predetermined index is y. In one embodiment, the running operating system predetermined index is updated by executing the SMI handler 210. Besides, exiting the system management mode after the running operating system predetermined index is updated in step S135. The step of exiting the system management mode comprises executing a Resume (RSM) instruction, such that the CPU 212 exits the system management mode and returns to the breaking point where the operating system 206 is interrupted when the system management interruption occurs.

On the other hand, when the user determines to restart the system after a system setting warning has occurred, the booting process is executed by the computer system when a restart instruction is received. During the power-on self test (POST) 202 of the BIOS and before the booting process is re-executed, an optimal system setting parameter corresponding to the running operating system predetermined index is obtained according to the updated running operating system predetermined index (for example, y). The computer system is then automatically set up based on the optimal system setting parameter (step S141). Consequently, for a restarted operating system, the computer system has completely optimized the system settings based on the type of the restarted operating system, such that the performance of the operating system is upgraded.

In the invention, the previous running operating system is registered and serves as the basis for booting the operating system next time. During a power-on self test of the BIOS, an optimal system setting parameter of the BIOS is obtained based on the operating system predetermined index stored in the memory to automatically set up the computer system. Therefore, the number of system setting options related to types of operating systems is reduced, operation of the computer system is simplified, convenience is improved, and human errors are minimized.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for automatically optimizing a configuration of a basic input/output system, suitable for configuring a computer system, the method comprising:
obtaining a running operating system predetermined index from a memory during a basic input/output system power-on self test;
obtaining an optimal system setting parameter corresponding to the running operating system;
automatically setting up the computer system according to the optimal system setting parameter;
performing a booting process to start an operating system;
obtaining an operating system index of the operating system;
comparing the operating system index with the running operating system predetermined index, issuing a system setting warning when the operating system index is not equal to the running operating system predetermined index; and
updating the running operating system predetermined index by using the operating system index as the updated running operating system predetermined index in the memory.

2. The method as claimed in claim 1, wherein the step of obtaining the operating system index of the operating system comprises:
obtaining an operating system string by querying an advanced configuration and power interface driver of the operating system; and
obtaining the operating system index of the operating system by referring to a look-up table according to the operating system string.

3. The method as claimed in claim 1, wherein the step of comparing the operating system index with the running operating system predetermined index comprises:
sending the operating system index to a system management interrupt handler through an input/output data port to trigger a system management interruption and enter a system management mode; and
in the system management mode, the system management interrupt handler comparing the operating system index with the running operating system predetermined index in the memory.

4. The method as claimed in claim 3, wherein the system management interrupt handler issues the system setting warning when the operating system index is not equal to the operating system predetermined index.

5. The method as claimed in claim 3, wherein the step of updating the running operating system predetermined index is performed by the system management interrupt handler.

6. The method as claimed in claim 3, further comprising:
exiting the system management mode after updating the running operation system predetermined index.

7. The method as claimed in claim 6, wherein the step of exiting the system management mode comprises executing a Resume instruction.

8. The method as claimed in claim 1, wherein the memory is a non-volatile random access memory.

9. The method as claimed in claim 1, further comprising:
after updating the running operating system predetermined index, re-executing the booting process and automatically setting up the computer system according to the updated running operating system predetermined index.

10. The method as claimed in claim 1, wherein the operating system predetermined index is a previous running operating system index or a system-default operating system index.
